(19) United States
(12) Patent Application Publication
(10) Pub. No.: US 2020/0369428 A1
(43) Pub. Date: Nov. 26, 2020

(54) PRODUCT TRANSFER TRAY, TRAY AND PRODUCT ASSEMBLY, AND INSTALLATION IMPLEMENTING SUCH A TRAY

(71) Applicant: PHARMED S.A.M., MONACO (MC)

(72) Inventor: Cédric BARADAT, CAGNES (FR)

(21) Appl. No.: 16/635,251

(22) PCT Filed: Jul. 26, 2018
(86) PCT No.: PCT/EP2018/070325

§ 371 Date: Jan. 30, 2020

(30) Foreign Application Priority Data
Aug. 3, 2017 (FR) 1757478

(51) Int. Cl. B65D 1/34; B65D 21/02

(52) U.S. Cl. CPC B65D 1/34; B65G 2203/044; B65D 2203/06; B65D 21/0213

(57) ABSTRACT

Disclosed is a tray for the transfer of at least one product, the product having on one of its faces or one of the faces of a packaging enclosing it, a first marking that can be read optically to identify the product, with the tray including at least one horizontal bottom wall on the internal upper face of which the product can be placed on one of its two large faces. The upper face of the horizontal bottom wall carries a second identifier marking for optical recognition to determine whether or not a product is present on the tray.

### TECHNICAL FIELD OF THE INVENTION

The invention concerns a tray to transfer products, especially products enclosed in a packaging.

The invention also concerns an installation for the automatic handling of products, each of which is carried on a tray according to the invention.

### BACKGROUND ART

More particularly, the invention concerns a tray that can be used for the automatic handling of products such as, for example, glasses lenses, notably with a view to storing them and preparing orders that include batches of different types of product.

In the course of their manufacturing, and especially at different steps of their manufacturing processes, such products are individualised and identified by marking means suited for subsequent operations.

For example, manufacturing a pair of glasses requires the production of at least two glasses lenses, each of which with different characteristics, for example, related to the desired degree of optical correction and also for example, to subsequent processing operations to be carried out on each lens.

Each lens, whether or not it has been preliminarily mass-produced, for example as blanks, is identified for example by a bar-code marking displayed on its final packaging.

Such a mark can also be provided directly onto the product itself.

Glasses lenses identified in this way can then be temporarily stored or dispatched directly to the end-user, especially to make the pair of glasses.

In order to automate the various steps of stowage, storage, batch preparation and dispatch, etc., it has become necessary to develop automated robotic systems that require being able to reliably use temporary means for storage and transfer of the concerned products.

The invention aims to propose a tray designed for this purpose.

### BRIEF SUMMARY OF THE INVENTION

The invention proposes a tray for the transfer of at least one product, the tray comprising at least one horizontal bottom wall on the internal upper face of which the product can be placed on one of its two large faces.

characterised in that said upper face of the horizontal bottom wall includes:
a marking for identification by optical recognition to determine whether or not a product is present on the tray; and
at least one ejection through-hole for the upward passage of a pin to eject a product present on the tray.

According to other characteristics of the invention:
said marking is arranged on an area on said upper face of the bottom wall that is masked by the product when a product is present on the tray;
the tray has a vertical wall which laterally retains a product present on the tray;
the outer face of the vertical wall carries another marking for identifying the tray, especially by optical reading;
the tray has two ejection through-holes distant from one another, and in that a marking is arranged on said upper face of the horizontal bottom wall, between these two ejection holes;
the marking is a one-dimensional or multidimensional bar-code;
the lower face of the bottom wall and the upper edge of the vertical wall have complementary shapes for positioning and/or guiding, such that they fit together by mutual interlocking when two identical trays are stacked;

The invention also proposes an assembly, comprising:
a tray for the transfer of at least one product, the tray comprising at least one horizontal bottom wall on the internal upper face of which the product can be placed on one of its two large faces.
and a product carrying, on one of its faces or on one of the faces of a packaging enclosing it, a first marking that can be read optically for identifying the product,
   assembly in which said upper face of the horizontal bottom wall of the tray is provided with a second identification marking for optical recognition to determine whether or not a product is present on the tray.

The invention also proposes an assembly, consisting of:
a tray according to the invention; and
a product carried by the tray, said product having on one of its faces or on one of the faces of a packaging enclosing it, a first marking that can be read optically for identifying the product.

The invention also proposes an installation for the automatic handling of products, each of which is being carried by a tray according to the invention,

characterised in that it includes a conveyor path on which trays rest by the lower faces of their bottom walls, and at least one optical sensor positioned vertically over the conveyor path in such a way as to be able to read, or not, any marking arranged on said upper face of the horizontal bottom wall of a tray, depending on whether or not there is a product on the tray facing said optical sensor.

According to other characteristics of the installation:
it includes at least one other optical sensor facing the vertical walls of the trays in such a way as to be able to read any marking that might be present on the outer face of the vertical wall of the tray facing said other optical sensor;
it includes an ejection station with at least one ejection pin that can be introduced vertically, up from below, through said at least one ejection hole in a tray present at the ejection station.

### BRIEF DESCRIPTION OF THE DRAWINGS

Other characteristics and advantages of the invention will emerge in the course of reading the following detailed description, for the understanding of which reference will be made to the appended drawings, in which:

FIG. 1 is a perspective view from above of a first embodiment of a tray according to the invention;

FIG. 2 is a side view of a long side of the lateral wall of the tray of FIG. 1;

FIG. 3 is a perspective view from below of the tray of FIG. 1;

FIG. 4 is a view from above of the tray in FIG. 1;

FIG. 5 is a perspective view from above of an envelope or sachet adapted for holding a product and being carried and transported by the tray of FIGS. 1 to 4;

FIG. 6 is a view similar to that in FIG. 4, showing an assembly of a tray and product in which, the tray is shown carrying, on the upper face of its bottom wall, an envelope as is illustrated in FIG. 5;

FIG. 7 is a perspective view of a stack of three identical trays assembled according to a first variant of the first embodiment;

FIG. 8 is a perspective view from below of one of the three identical trays of FIG. 7;

FIG. 9 is a perspective view of a stack of two identical trays assembled according to a second variant of the first embodiment;

FIG. 10 is an exploded perspective view of the two identical trays of FIG. 9;

FIG. 11 is a perspective view from below of one of the two identical trays of FIGS. 9 and 10;

FIG. 12 is a detailed view from below that shows one of the corners of one of the two identical trays of FIGS. 9 and 10;

FIG. 13 is a schematic representation of a marking reading station, that is a part of an installation using trays according to the invention;

FIG. 14 is a schematic representation of an ejection station of a product from the tray, that is a part of an installation using trays according to the invention.

### DETAILED DESCRIPTION OF THE DRAWINGS

In the following description, components with the same structure or similar functions will be referred to using the same references.

In the remaining part of the description, longitudinal, vertical and transverse axes will be referred to, in a non-limiting way, as shown by the “L,V,T” trihedron in the figures. A horizontal plane extending longitudinally and transversely is also defined.

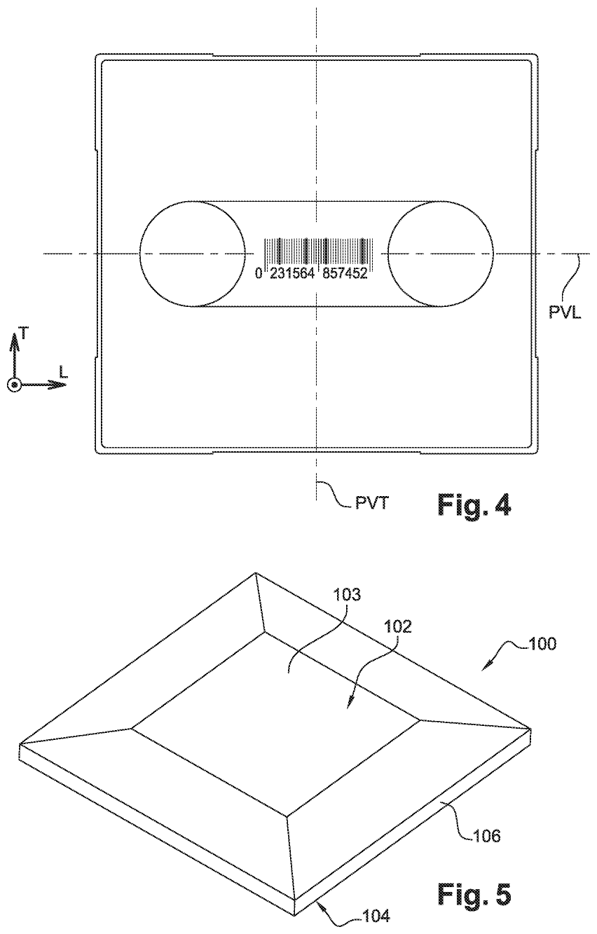

In the first embodiment and its variants, each tray has a double symmetrical design with respect to two vertical planes, a longitudinal PVL and a transversal PVT, shown in FIG. 4.

Each tray is, for example, produced by moulding of a plastic material.

According to the invention, the notion of product covers for example a glasses lens, or ophthalmic lens, finished or unfinished, a “raw” ophthalmic lens or a lens blank, a contact lens in individual packaging like a blister pack, a pair of glasses frame, precious or semi-precious stones, pearls inside an envelope or a sachet, links for decorative or jeweller's bracelets or necklaces, etc.

As a rule, the product is enclosed in a packaging such as a sachet or an envelope, for example rectangular or square in shape, and globally delimited by two opposed large surfaces, more or less flat, and possibly with a peripheral lateral wall.

It is therefore possible that the packaging carries on part of its outer surface a first identification marking that allows optical recognition of which product is contained inside the packaging.

If the product is not enclosed in a packaging, it can nevertheless sometimes include/directly carry a first identification marking that allows the optical recognition of which product is contained inside the packaging.

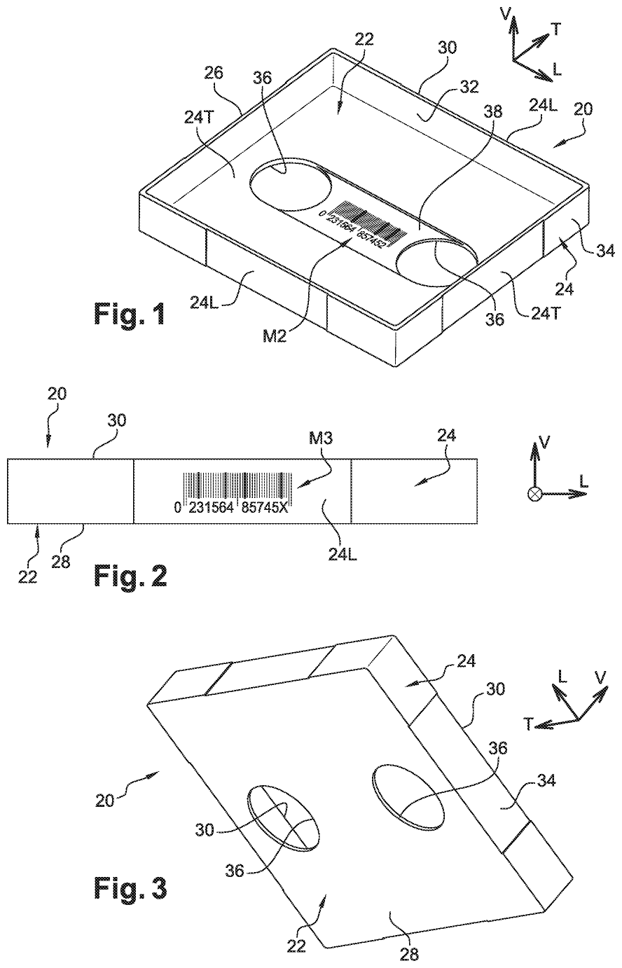

The tray 20 shown in FIGS. 1 to 4 and 6 essentially consists of a horizontal bottom wall 22 having here a rectangular outline, and a peripheral side wall 24, which extends continuously around all four sides of the bottom wall 22

Thus, in a non-limiting way, the tray 20 here comprises a single inner compartment which is upwardly vertically open.

The bottom wall is delimited by an internal upper face 26 and an outer lower face 28 by means of which the tray can rest on a shelf or, by way of another example, on the strap or the belt of a conveyor to transport or transfer the tray.

The side wall 24 extends vertically upwards from the bottom wall and is delimited by a continuous upper horizontal edge 30.

The side wall has two large longitudinal sides 24L and two smaller transverse sides 24T.

The side wall 24 is delimited by its inner face 32 and outer face 34.

Here, the horizontal bottom wall 22 has two ejection through-holes 36 having a circular outline which are centred transversely and aligned longitudinally.

Between the two ejection holes 36, the internal upper face 26 of the horizontal bottom wall 22 includes a central area 38 which is a marking area according to the invention.

Without limitation, the marking area 38 is slightly hollow with respect to the plane of internal upper face 26.

By way of an example here, the marking area 38 carries a bar-code M2 that constitutes a second marking according to the invention that, for example, can be read and identified by any suitable optical reader, through the open upper face of tray 20.

As it can be seen, in particular in FIG. 4, if there is nothing on the tray, i.e. notably in the compartment on the tray 20, the second marking M2 can be seen.

As it can be seen in FIG. 2, one of the sides of side wall 24, here a large longitudinal side 24L, has on its outer face 34 another marking M3 in the form of a bar-code that constitutes a third marking according to the invention for identification of the tray 20, that can for example be read and identified by any suitable optical reader facing the outer face of the tray.

A tray 20 can carry a similar third marking M3 on the outer face 34 of each of the four sides 24L and 24T of the side wall 24 in such a way as to allow identification of the tray 20 whichever of its sides is pointing towards a reader provided and positioned for this purpose.

FIG. 5 is a schematic representation of a packaging 100 in the form of an envelope or sachet which here have a substantially square outline.

Packaging 100 is delimited by a large upper face 102 and a large lower face 104 which are substantially parallel.

Packaging 100 also has a peripheral lateral wall 106 with four continuous sides extending all along the edges of the large faces, both upper 102 and lower 104.

Packaging 100 is for example an envelope or sachet made of paper, or possibly a box made of cardboard or any other material.

It can contain for example a glasses lens.

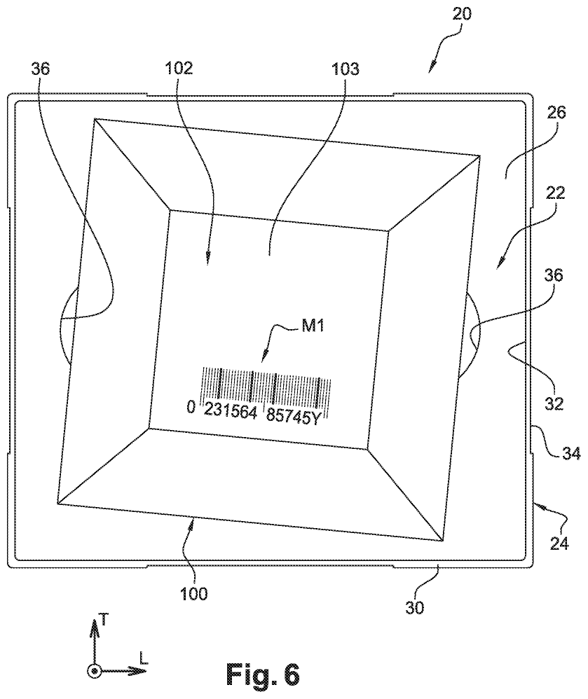

As can it be seen in FIG. 6, on the outer side 103 of its large upper face 102 or possibly on the outer side of each of its two large faces, upper face 102 and lower face 104, the packaging 100 carries a marking M1 for example in the form of a bar-code, that constitutes a first marking according to the invention to identify the packaging 100 and the product it contains, and that can for example be read and identified by any suitable optical reader positioned facing it.

As it can be seen in FIG. 6, when packaging 100 is placed on the external upper face 26 of the bottom wall 22 of the tray 20 (on which it is laterally held in place by vertical wall 24), packaging 100 hides—here completely—marking area 38 and the second marking M2 in such a way that the latter can no longer be read by an optical reader.

When the second marking M2 cannot be detected or read, it means that a product in its packaging 100 is on the tray 20.

In contrast, if there is no product present on the internal upper face 26 of the bottom wall 22, a reader can detect or read the second marking M2 thereby showing that the tray 20 is “empty”.

If a tray has been positioned “upside down”, i.e. the wrong way up, it is the outer face 28 of its bottom wall 22 which points up and, since this outer face 28 does not carry any marking, this particular state can also be detected.

As a variant, the second marking M2 can be the same on all trays used in a given installation and/or identical to the third tray identification marking M3.

As it can also be seen on FIG. 6, in position on the bottom wall 22 of a tray 20, a packaging 100 extends at least partially to face at least one ejection hole 36.

To remove a product or its packaging 100 from the compartment on the tray, it must be extracted, at least partially, vertically from the bottom up.

To make it easier to grip it, at least one ejection pin can be passed vertically from the bottom up though an ejection hole 36.

The various markings discussed above can be of any suitable type and are notably not limited to one-dimensional or multidimensional bar-codes.

In particular for the second marking M2 that indicates whether a product is present or not, it can consist of an area with a colour different from the colour of the remaining part of the tray 20.

Similarly, the principle according to the invention is not limited to a tray 20 with a single compartment to hold one product.

Thus, a single tray, for example for the production of a pair of glasses, can contain three neighbouring compartments, two for the glasses lenses and a third compartment for the frame.

The internal upper face 26 of the bottom wall 22 delimiting each compartment can then carry a second marking M2, possibly specifying the nature of the product it may, or may not, be holding.

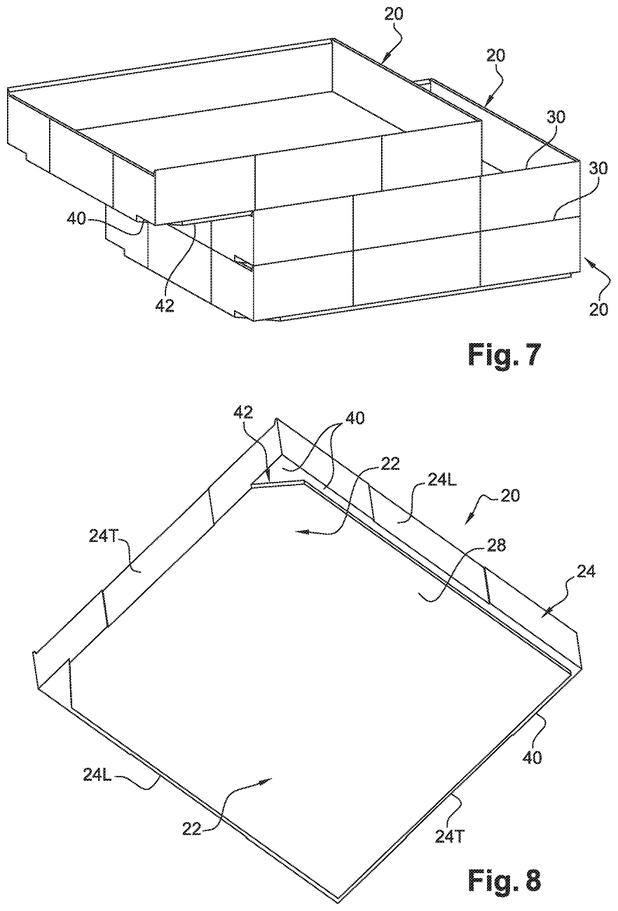

FIGS. 7 and 8 show a first variant embodiment of a tray according to the invention that notably allows vertical storage by means of the stacking of a series of identical trays 20.

These figures only show the changes made to make stacking possible; neither the various marking means not the ejection holes are shown.

As it can be seen especially in detail in FIG. 8, the lower face 28 of the bottom wall 22 includes, along its two large longitudinal sides 24L and one of its small “back” transverse sides 24T, a peripheral recess 40, the dimensions of which are such that the projecting part 42 delimited by the recess 40 fits “inside” the tray 20 immediately below to rest on the upper edge 30 of said tray.

As illustrated schematically in FIG. 7 for the uppermost of the three illustrated trays, this design also makes it possible to slide each tray 20 horizontally over the tray immediately below, on which it is resting.

Moreover, backward sliding motion is limited longitudinally with respect to the lower tray.

Thus, especially when the handling is automated with a clamp on a robotic head, trays 20 can be handled and vertically stacked directly and/or by sliding them horizontally along the L-axis.

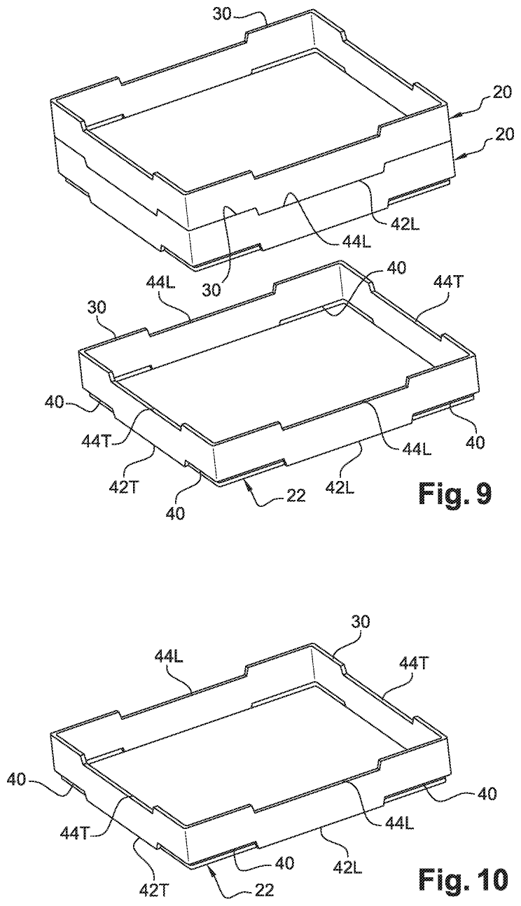

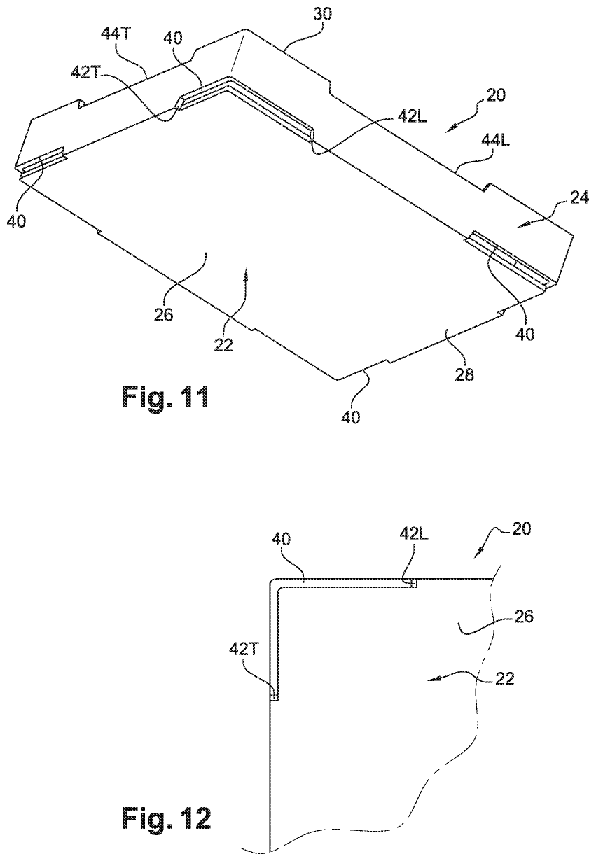

A second variant of stacking means is illustrated in FIGS. 9 to 12, in which identical trays 20 can be stacked and superimposed reliably and stably, but here without the possibility of relative sliding in the horizontal plane.

To this end, the external lower face 28 has, at each of its four corners, a recess 40 while the upper edge 30 of the side wall 24 has a matching profile to make it possible to interlock and superimpose two identical trays 20.

Between two successive recesses 40, the bottom wall thus has a projection 42L, 42T respectively.

To this end, the upper edge 30 of the side wall 24 has, on each of its sides 24L, 24T, a central notch 44L, 44T respectively, which is sized to accommodate a matching projection 42L, 42T respectively.

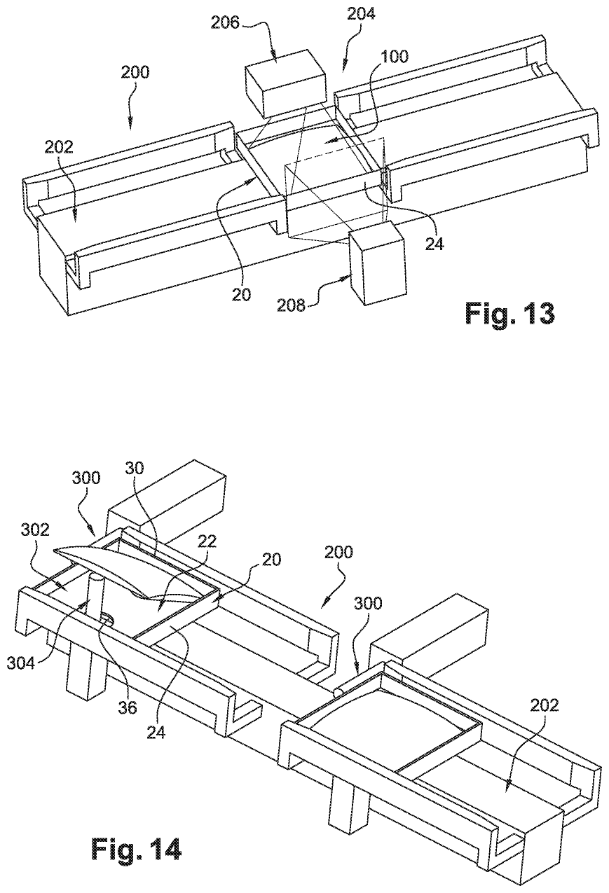

FIG. 13 shows a conveyor 200 on the upper face 202 of which trays sit and are moved along, such as the tray 20 illustrated that is facing a reading station 204.

Schematically and in a non-limiting manner, the reading and identification station 204 includes a first upper camera 206 positioned over the belt that can scan vertically downwards over the open upper face of a tray 20, to read from it:
either a marking on the upper face of a product on a tray 20, for example the abovementioned first marking M1;
or a second marking M2, as mentioned above, arranged in the bottom of the tray if the latter is, for example, upside down;
or the absence of any marking if, for example, a tray is in upside down.

Schematically and in a non-limiting manner, the reading and identification station 204 includes a second lateral camera 208 positioned on one side of the belt that can horizontally scan the side of the tray 20, for example for a marking such as the abovementioned third marking M3.

FIG. 14 shows a conveyor 200 on the upper face 202 of which trays rest and are moved along, such as the two illustrated trays 20.

The movement of the trays 20 can be stopped by remote-controlled blocking pins 300 projecting laterally above the conveyor belt.

The movement of the tray 20, farthest to the left, is stopped at the level of a station 302 for the partial ejection of a product 100 contained in the associated tray 20.

The ejection station 302 essentially consists of a controlled ejection pin 304, which can move vertically between a low, retracted position and a high, active illustrated position, in which the ejection pin 304 projects through an ejection hole 36 in the tray 20 to lift at least part of a packaging 100 over the plane of the upper edge 30.

1. A tray (20) for the transfer of at least one product, the tray (20) comprising at least one horizontal bottom wall (22) on the internal upper face (26) of which the product can be placed on one of two large faces of the product, wherein said upper face (26) of the horizontal bottom wall (22) includes:
a marking (M2) for identification by optical recognition to determine whether or not a product is present on the tray (20); and
at least one ejection through-hole (36) for the upward passage of a pin (304) to eject a product present on the tray (20).

2. The tray (20) according to claim 1, wherein said marking (M2) is arranged on an area (38) on said upper face (26) of the bottom wall (22) that is masked by the product when a product is present on the tray (20).

3. The tray (20) according to claim 1, further comprising a vertical wall (24) which laterally retains a product present on the tray (20).

4. The tray (20) according to claim 3, wherein the outer face (34) of the vertical wall (24) carries another marking (M3) for identifying the tray (20), especially by optical reading.

5. The tray (20) according to claim 1, further comprising two ejection through-holes (36) distant from one another, wherein a marking (M2) is arranged on said upper face (26) of the horizontal bottom wall (22), between these two ejection holes (36).

6. The tray (20) according to claim 1, wherein the marking (M2, M3) is a one-dimensional or multidimensional bar-code.

7. The tray (20) according to claim 3, wherein the lower face (28) of the bottom wall (22) and the upper edge (30) of the vertical wall (24) have complementary shapes for positioning and/or guiding, such that they fit together by mutual interlocking when two identical trays (20) are stacked.

8. An assembly comprising:
a tray (20) for the transfer of at least one product, the tray (20) comprising at least one horizontal bottom wall (22) on the internal upper face (26) of which the product can be placed on one of two large faces of the product
and a product carrying, on one face of the product (102) or on one of the faces of a packaging (100) enclosing it the product, a first marking (M1) that can be read optically for identifying the product,
assembly in which said upper face (26) of the horizontal bottom wall (22) of the tray is provided with a second identification marking (M2) for optical recognition to determine whether or not a product is present on the tray (20).

9. An assembly comprising:
a tray according to claim 1; and
a product carried by the tray, said product having on one face of the produce or on one of the faces (102) of a packaging (100) enclosing the product, a first marking (M1) that can be read optically for identifying the product.

10. An installation for the automatic handling of products, each of which is being carried by a tray (20) according to claim 4,
the installation comprising a conveyor path (200, 202) on which trays (20) rest by the lower faces of their bottom walls (22), and at least one optical sensor (206) positioned vertically over the conveyor path in such a way as to be able to read, or not, any marking (M2) arranged on said upper face (26) of the horizontal bottom wall (22) of a tray (20), depending on whether or not there is a product (100) on the tray (20) facing said optical sensor.

11. The installation according to claim 10, further comprising at least one other optical sensor (208) facing the vertical walls (24) of the trays (20) in such a way as to be able to read any marking (M3) that might be present on the outer face of the vertical wall of the tray (20) facing said other optical sensor (208).

12. The installation according to claim 10, further comprising an ejection station (302) with at least one ejection pin (304) that can be introduced vertically, up from below, through said at least one ejection hole (36) in a tray (20) present at the ejection station (302).

13. The tray (20) according to claim 2, wherein the marking (M2, M3) is a one-dimensional or multidimensional bar-code.

14. The tray (20) according to claim 3, wherein the marking (M2, M3) is a one-dimensional or multidimensional bar-code.

15. The tray (20) according to claim 4, wherein the marking (M2, M3) is a one-dimensional or multidimensional bar-code.

16. The tray (20) according to claim 5, wherein the marking (M2, M3) is a one-dimensional or multidimensional bar-code.

17. An assembly comprising:
a tray according to claim 2; and
a product carried by the tray, said product having on one face of the produce or on one of the faces (102) of a packaging (100) enclosing the product, a first marking (M1) that can be read optically for identifying the product.

18. An assembly comprising:
a tray according to claim 3; and
a product carried by the tray, said product having on one face of the produce or on one of the faces (102) of a packaging (100) enclosing the product, a first marking (M1) that can be read optically for identifying the product.

19. An assembly comprising:
a tray according to claim 4; and
a product carried by the tray, said product having on one face of the produce or on one of the faces (102) of a packaging (100) enclosing the product, a first marking (M1) that can be read optically for identifying the product.

20. An assembly comprising:
a tray according to claim 5; and
a product carried by the tray, said product having on one face of the produce or on one of the faces (102) of a packaging (100) enclosing the product, a first marking (M1) that can be read optically for identifying the product.
